(19) United States
(12) Patent Application Publication
(10) Pub. No.: US 2010/0302277 A1
(43) Pub. Date: Dec. 2, 2010

(54) Image Modification for Web Pages

(75) Inventors: Hui Jiang, Austin, TX (US); Indran Naick, Cedar Park, TX (US); Rohit R. Sahasrabudhe, Austin, TX (US); Jeffrey K. Wilson, Austin, TX (US)

Correspondence Address: Greg Goshorn, P.C., 9600 Escarpment, Suite 745-9, AUSTIN, TX, 78749, US

(73) Assignee: INTERNATIONAL BUSINESS MACHINES CORPORATION, Armonk, NY (US)

(21) Appl. No.: 12/472,471

(22) Filed: May 27, 2009

(51) Int. Cl. G06F 15/16; G06F 17/00; G09G 5/38; G06F 3/048

(52) U.S. Cl. 345/650; 715/234; 709/203; 345/661; 715/840

(57) ABSTRACT

Provided is a method of providing a feature in a web browser that enables a user to adjust a downloaded image to correctly display on the user's computer screen. The disclosed technology provides a mechanism that enables a user to adjust images in a web page. The claimed subject matter provides “rotate” buttons, displayed in conjunction with the particular image, so that the user can rotate the image into an appropriate orientation. In addition, a “sizing” button or buttons are provided. Different web pages may display differently on different computer screens, depending upon both the size of the screen and the size of the window in which the web page is displayed. The disclosed technology enables a user to adjust, in addition to the rotation, the size of an image so that the image displays properly and completely on the user's screen and in the corresponding window.

### BACKGROUND

1. Technical Field

The claimed subject matter relates generally to display of images on a web site and, more specifically, to a method for automatically adjusting, on the client side, the orientation and size of an image displayed on a web page.

2. Description of the Related Art

One of the major developments in the field of computing is degree to which computing devices have become interconnected. Once, machines were typically stand-alone devices; now, most computing devices are connected to a network. Examples of networks include local area networks (LANs) and wide area networks (WANs). Both of these types of networks, as well as other types, are now also typically connected to a larger network, the Internet.

The development of the Internet, which is supported by thousands, if not millions, of interconnected computers spanning the globe, has spawned the development of web sites, both commercial and non-commercial, to utilize this new medium. Some examples include, but are not limited to, commercial sites, such as Amazon, Yahoo and eBay; and non-commercial services such as Facebook and Craigslist. Material, or content, posted on these websites is often provided by users, each with a different level of computing and/or programming experience and accessed by means of web browsers.

Although experienced computer users may easily establish a web site, post content or “browse” a website, less experienced users often have difficulty executing these tasks. Examples of issues that arise for an inexperienced user include spelling, capitalization and typographical errors and well as orientation and sizing issues associated with images. Further, often these issues arise not only when content is posted, but also when material is downloaded by a second party. Problems with spelling, capitalization and typographical errors are easily fixed using commonly available tools such as a spell checker. Problems with images are more problematic because of a lack of tools that address these issues.

### SUMMARY OF THE CLAIMED SUBJECT MATTER

Provided is a method of providing a feature in a web browser on the client side that enables a user to adjust a downloaded embedded image in a received web page to correctly display on the user's computer screen. The proliferation of websites and posted content provided by inexperienced users creates a situation in which content is displayed improperly. For example, and embedded image transmitted with a web page in a website such as Craigslist may either be oriented inappropriately or too large or small for the screen of the user who downloads the web page. Web browsers do not provide a mechanism for adjusting such displayed images.

The disclosed technology provides a mechanism that enables a user to adjust images in a web page. For example, if a particular downloaded image is rotated in such a manner that the subject is hard to examine, the claimed subject matter provides “rotate” buttons, displayed in conjunction with the particular image, so that the user can rotate the image into an appropriate orientation. In addition, a “sizing” button or buttons are provided. Different web pages may display differently on different computer screens, depending upon both the size of the screen and the size of the window in which the web page is displayed. The disclosed technology enables a user to adjust, in addition to the rotation, the size of an image so that the image displays properly and completely on the user's screen and in the corresponding window.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE FIGURES

A better understanding of the claimed subject matter can be obtained when the following detailed description of the disclosed embodiments is considered in conjunction with the following figures, in which:

FIG. 1 is a block diagram of one example of a computing system architecture that supports the claimed subject matter.

FIG. 2 is a block diagram of an Image Modification and Display Tool (IMADT), introduced in FIG. 1, in greater detail.

FIG. 3 is a block diagram of a window that incorporates functionality provided by the IMADT of FIGS. 1 and 2.

FIG. 4 is a block diagram of the window of FIG. 3, showing an image modified in conformance with the claimed subject matter.

FIG. 5 is a flowchart of a Setup IMADT process that implements one aspect of the claimed subject matter.

FIG. 6 is a flowchart of an IMADT process that implements a second aspect of the claimed subject matter.

### DETAILED DESCRIPTION OF THE FIGURES

Although described with particular reference to a web browser, the claimed subject matter can be implemented in any graphical user interface in which automatic reorientation and resizing of images is desirable. Those with skill in the computing arts will recognize that the disclosed embodiments have relevance to a wide variety of computing-environments in addition to those described below. In addition, the methods of the disclosed technology can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for image detection and modification. The term “programmed method”, as used herein, is defined to mean one or more process steps that are presently performed; or, alternatively, one or more process steps that are enabled to be performed at a future point in time. The term “programmed method” anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

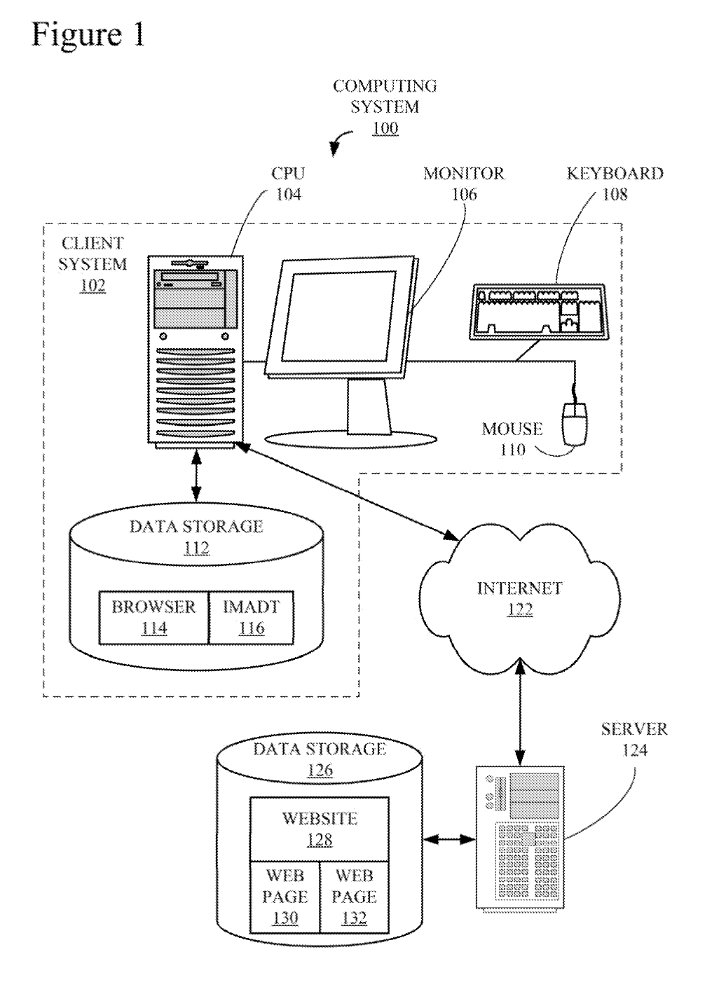

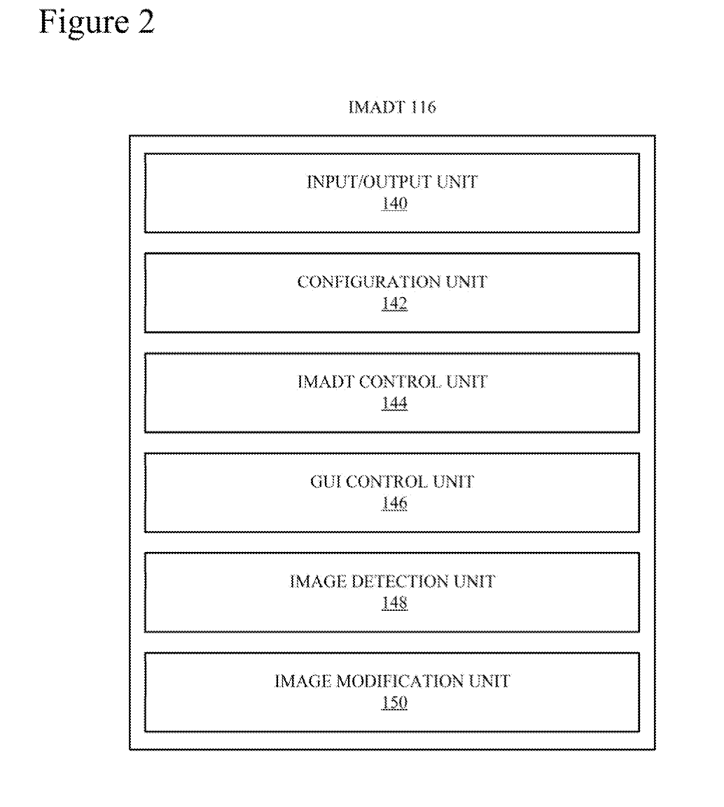

FIG. 1 is a block diagram of one example of a computing system architecture 100 that supports the claimed subject matter. A client system 102 includes a central processing unit (CPU) 104, coupled to a monitor 106, a keyboard 108 and a mouse 110, which together facilitate human interaction with computing system 100 and client system 102. Also included in client system 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown). Data storage 112 is illustrated storing a web browser application, or “browser,” 114 and an image modification and display tool (IMADT) 116, configured in accordance with the claimed subject matter. IMADT 116 is illustrated as part of browser 114 but may be a stand-alone application or a plug-in module installed to work in conjunction with browser 114. Those with skill in the computing arts should be familiar with browsers and plug-in modules. IMADT 116 is described in more detail below in conjunction with FIGS. 2-6.

Client system 102 and CPU 104 are connected to the Internet 122, which is also connected to a server computer 124. Although in this example, CPU 104 and server 124 are communicatively coupled via the Internet 122, they could also be coupled through any number of communication mediums such as, but not limited to, a local area network (LAN) (not shown).

Server 124 is coupled to a data storage component 126, which may either be incorporated into server 124, i.e. an internal device, or attached externally to server 124 by means of various, commonly available connection devices such as but not limited to, a universal serial bus (USB) port (not shown). Data storage 126 is illustrated storing data related to a website 128, which includes two (2) web pages 130 and 132. It should be noted that a typical website such as website 128 would include components other than merely web pages and more than two (2) web pages, but for the sake of simplicity only the two web pages are shown. It should be noted there are many possible computing system configurations, of which computing system 100 is only one simple example.

FIG. 2 is a block diagram of IMADT 116, first introduced in FIG. 1, in greater detail. As explained above, IMADT 116 may be an integrated component of browser 114 (FIG. 1), a standalone component on client system 102 (FIG. 1) or a plug-in module, employed in conjunction with browser 114 or some other image display tool. In this example, IMADT 116 is stored on data storage 112 (FIG. 2) and executed on CPU 104 (FIG. 1) of client system 102. Throughout this Specification, examples of the operation of IMADT 116 are described in conjunction with the downloading of web pages 130 (FIG. 1) and 132 (FIG. 1) of web site 128 (FIG. 1).

IMADT 116 includes an Input/Output (I/O) unit 140, a configuration unit 142, an IMADT control unit 144, a GUI control unit 146, an image detection unit 148 and an image modification unit 150. It should be understood that the representation of IMADT 116 in FIG. 2 is a logical model. In other words, components 140, 142, 144, 146, 148 and 150 may be stored in one or separate files and loaded and/or executed on CPU 104 either as a single system or as separate processes interacting via any available inter process communication (IPC) techniques.

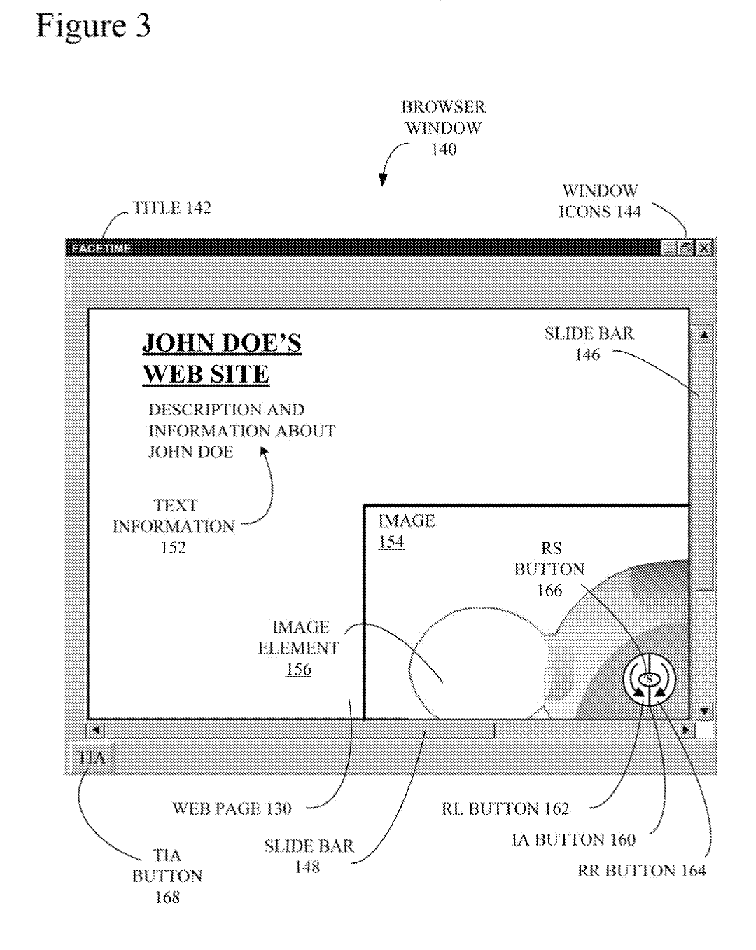

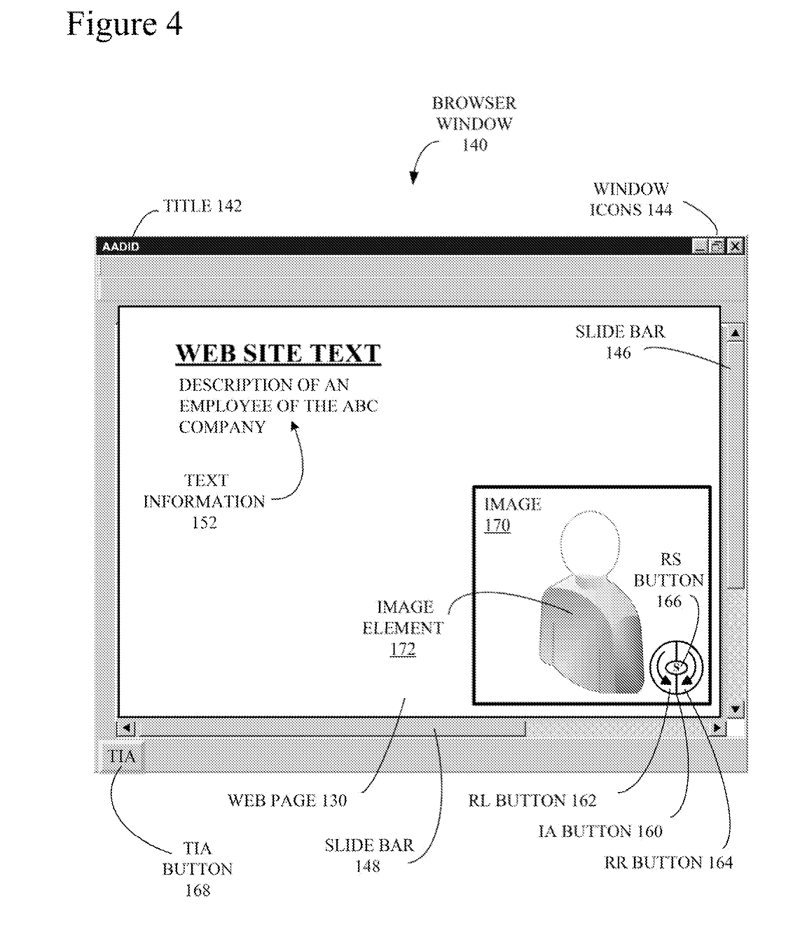

I/O module 140 handles any communication IMADT 116 has with other components of client system 102. Configuration unit 142 stores parameter settings that control the operation of IMADT 116. Examples of the types of information stored in configuration unit 142 include, but are not limited to, a parameter that controls whether IMADT 116 executes automatically in conjunction with browser 114 or must be initiated by a user and a parameters corresponding to the dimensions, display options of monitor 106 (FIG. 1), display options corresponding to an IA button (see FIGS. 3 and 4) and a predetermined sequence of keys for initiating IMADT 116.

IMADT control unit 144 includes logic for the operation of IMADT 116, i.e. processing associated with the control and coordination of modules 140, 146, 148 and 150 in conformity with the data stored in configuration unit 142. GUI control unit 146 interacts with browser 114 to manage the display of web pages on monitor 106. Image detection unit scans a web page such as web pages 130 and 132 (FIG. 1) displayed in conjunction with a website such as website 128 (FIG. 1). GUI control unit 146 interacts with browser 114 to control the display of web pages in conformance with the claimed subject matter.

Image Detection unit 148 scans a web page, such as web page 130, to detect the elements of web page 130 that are images. Image Modification unit 150 modifies images detected by image detection unit 148 in accordance with a user's intentions to implement the functionality of IMADT 116. Components 140, 142, 144, 146, 148 and 150 are described in more detail below in conjunction with FIGS. 3-6.

FIG. 3 is a block diagram of a browser window, or window, 140 that illustrates functionality provided by IMADT 116 of FIGS. 1 and 2. In the following example, window 140 is generated by browser 114 (FIGS. 1 and 2) on client system 102 (FIG. 1), displayed on monitor 106 (FIG. 1) and corresponds to a web page 130 (FIG. 1) that displays information about a fictitious person, John Doe. Window 140 includes a title 142, i.e. “Facetime,” that is the name of a fictitious web site 128 (FIG. 1) that displays user provided content on individuals. It should be noted that the particular subject of the window is used only for the purposes of illustration and that the disclosed technology is relevant to any web page that displays images. Other examples include, but are not limited to, sites that sell products or provide news. Window icons 144 enable a user to minimize, maximize or close window 140. Window 140 also provides slider bars, or sliders, 146 and 148 that enable a user to reposition web page 130 within window 140. Those with skill in the computing arts should be familiar with the use of window icons and slider bars.

Displayed in window 140 as part of web page 130 is text information 152, which describes John Doe, and an image 154, which is a picture of John Doe. Within image 154, an image element 156 is, in this example, the actual representation of John Doe. It should be noted that image element 156 is not only oriented in an inappropriate fashion with respect to web page 130 but is also clipped, or cut off, on the two edges that abut the bottom and right side of window 140. Of course, a user would be able to reposition web page 130 by manipulating slide bars 146 and 148 so that image 154 is displayed completely but, in doing so, a portion of text information 152 may be clipped or obscured.

Also included in image 154 is an Image Adjustment (IA) button 160 that executes the functionality of the claimed subject matter. It should be understood that IA button 160 is not a part of image 154 but rather is displayed on top of image 154 by IMADT 116 (FIGS. 1 and 2) in conjunction with browser 114 (FIGS. 1 and 2). IA button includes a Rotate Left (RL) button 162, a Rotate Right (RR) button 164 and a Resize (RS) button 166. If a user positions a screen cursor (not shown) over RL button 162 and presses a button on mouse 110 (FIG. 1), or “clicks” on RL button 162, image 154 is rotated in a counter clockwise direction. If the user clicks on RR button 164, image 154 is rotated in a clockwise direction. If the user clicks on RS button 166, the size of image 154 is adjusted so that image 154 is displayed within window 140 in its entirety. In this manner, a user is able to easily manipulate image 154 so that image 154, and image element 156, is both correctly oriented and not clipped.

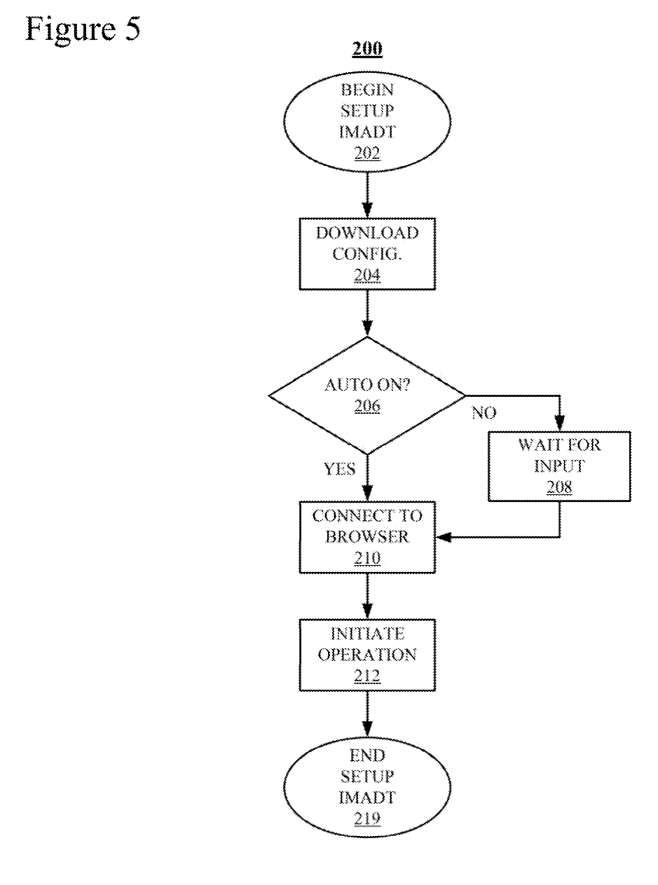

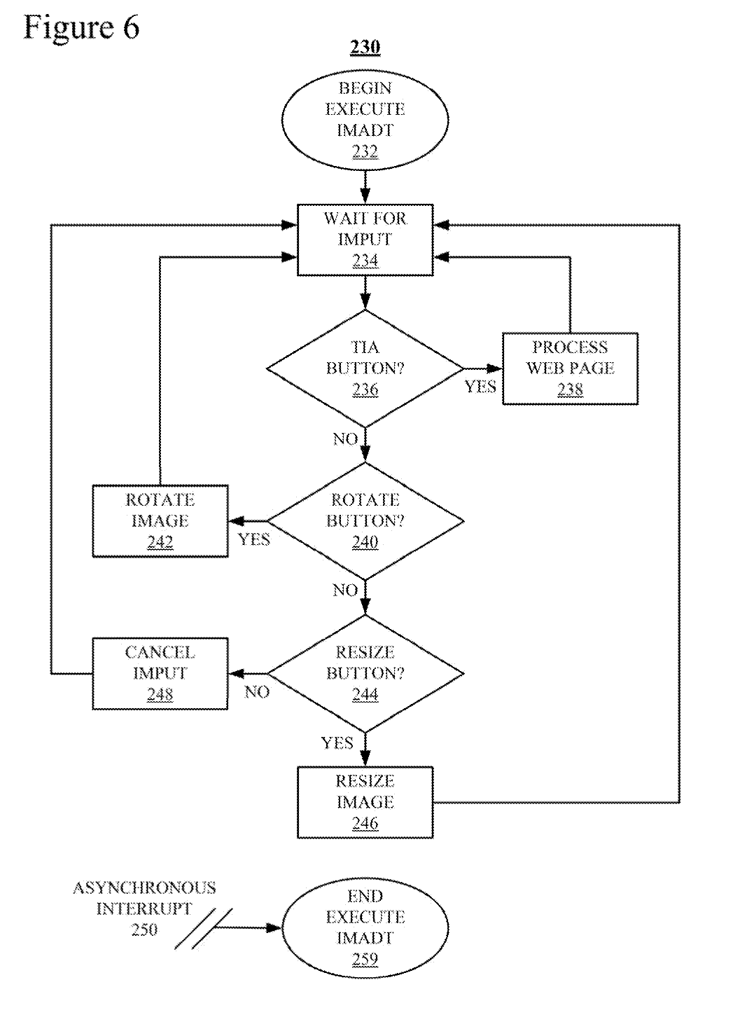

Browser window 140 also includes a Toggle IA (TIA) button 168, which enables a user to toggle between a display of IA button 160 on image 170 and any other images and removing IA button 160 from images on web page 130. Processes that implement the both the display and execution functions of IA button 160 are described below in conjunction with FIGS. 5-6.

FIG. 4 is a block diagram of window 140 and web page 130 of FIG. 3, including title 142, window icons 144, slider bars 146 and 148, TIA button 168 and text info 152. In this example, window 130 displays an image 170, corresponding to image 154 (FIG. 3) that has been modified by IMADT 116 (FIGS. 1 and 2) in conformance with the claimed subject matter. In other words, in this example, image 170 is image 154 once a user has clicked on RR button 164 (FIG. 3) and RS button 166 (FIG. 3). Image element 172 corresponds to image element 156, which has been rotated and resized in conjunction with image 154. It should be noted that the entire image 170 is displayed in window 140 and no portion of text information 152 is obscured. Processes associated with IMADT 116 and the manipulation of image 154 to generate image 170 are described below in conjunction with FIGS. 5 and 6.

FIG. 5 is a flowchart of a Setup IMADT process 200 that implements one aspect of the claimed subject matter, specifically the initial setup of IMAT 116 (FIGS. 1 and 2). Process 200 is stored in data storage 112 (FIG. 1) and executed in conjunction with IMADT 116 on CPU 104 (FIG. 1) of client system 102 (FIG. 1). As explained above in conjunction with FIG. 1, although IMADT 116 is illustrated as part of browser 114 (FIG. 1), IMADT 116 may be a stand-alone application or a plug-in module installed to work in conjunction with browser 114. Logic associated with process 200 is stored in conjunction with IMADT control unit 144 (FIG. 2).

Process 200 starts in a “Begin Setup IMADT” block 202 and proceeds immediately to a “Download Configuration (Config.)” block 204. During block 204, process 200 retrieves configuration parameters from configuration unit 142 (FIG. 2) of IMADT 116. Examples of configuration parameters include, but are not limited to, a setting indication that IMADT 116 is loaded automatically upon startup (see block 206) and display parameters such as the size and position of IA button 160 (FIGS. 3 and 4). During an “Auto On?” block 206, process 200 determines whether or not the configuration parameters downloaded during block 204 indicate that IMADT 116 is configured to automatically attach process images associated with browser 114 or to wait for a user to indicate that either a particular image or every image in a particular web page should have an IA button 160 displayed. If IMADT 116 is not configured for auto on, process 200 proceeds to a “Wait for Input” block 208 during which process 200 pauses and waits for specified user input indicating an intention to implement the functionality of IMADT 116. Typically, a user indicates such an intention by typing a predetermined sequence of input keys on keyboard 108 (FIG. 1) as defined in configuration unit 142.

Once process 200 receives a user indication to implement IMADT 116, or, if during block 206, process 200 determines that IMADT 116 is configured for auto on, control proceeds to a “Connect to Browser” block 210. During block 210, process 200 identifies browser 114, based up parameters stored in configuration unit 142 and attaches to browser 114 in a manner that enables IMADT 116 to detect images (see 148, FIG. 2) such as image 154 (FIG. 3). During an “Initiate Operation” block 212. Processing associated with block 212 is described below in conjunction with FIG. 6. Finally, control proceeds to an “End Setup IMADT” block 219 in which process 200 is complete.

FIG. 6 is a flowchart of an IMADT process 230 that implements nominal operation of IMADT 116 (FIGS. 1 and 2). Like process 200 (FIG. 5), process 230 is stored in data storage 112 (FIG. 1) and executed in conjunction with IMADT 116 (FIGS. 1 and 2) on CPU 104 (FIG. 1) of client system 102 (FIG. 1). Process 230 is spawned by process 200 (see block 212; FIG. 5).

Process 230 starts in a “Begin Execute IMADT” block 232 and proceeds immediately to a “Wait for Input” block 234. During block 234, process 230 is in a suspended state waiting for a user input via I/O unit 140 (FIG. 2). In this example, user inputs take the form of a “click” of mouse 110 (FIG. 1) on TIA button 168 or sections 162, 164 and 166 of IA button 160, all described above in conjunction with FIGS. 3 and 4.

Once user input is received, process 230 proceeds to a “TIA button?” block 236 during which process 230 determines whether or not the user input received during block 234 represents a click on TIA button 168. If so, process 230 proceeds to a “Process Web Page” block 238. During block 238, process 230 scans the web page, in this example web page 130 (FIGS. 1, 3 and 4), to either display or remove IA button 160 (FIGS. 3 and 4) from images, depending upon the current state of the display (see 146, FIG. 2). In other words, TIA button 168 toggles the display of IA button 160 on and off, i.e. if IA button 160 is currently displayed in an image or images button 160 is removed and, if button 160 is currently not displayed, button 160 is added to images or an image.

If, during block 236, process 230 determines that the user input received during block 234 is not a click on TIA button 168, control proceeds to a “Rotate Button?” block 240. During block 240, process 230 determines whether or not the user input received during block 234 represents a click on either RL button 162 or RR button 164 of IA button 160, all described above in conjunction with FIGS. 3 and 4. If so, process 230 proceeds to a “Rotate Image” block 242. During block 242, process 230 associates the button 160 from which the input was initiated to a specific image, in this example image 154 (FIG. 3), and then manipulates the image according to the user's intentions, i.e. by rotating the image either clockwise of counterclockwise. Process 230 then returns to block 234 and processing continues as described above and below.

If, during block 240, process 230 determines that the user input received during block 234 does not represent a click on either RL button 162 or RR button 164), control proceeds to a “Resize Button?” block 246. During block 246, determines whether or not the user input received during block 234 represents a click on RS button 166 of IA button 160, described above in conjunction with FIGS. 3 and 4. If so, control proceed to a “Resize Image” block 246 during which process 230 associates the button 160 from which the input was initiated to a specific image, in this example image 154, calculates the boundaries of the associated web page 130 (FIG. 3) in window 140 (FIG. 3) and then manipulates image 154 by adjusting the size of image 154 to fit within the boundaries (see 150, FIG. 2). Process 230 then returns to block 234 and processing continues as described above and below.

If, during block 244, process 230 determines that the user input received during block 234 does not represent a click on RS button 166, control proceeds to a “Cancel Input” block 248 during which the input received during block 234 is ignored and control proceeds to block 234 and processing continues as described above.

Finally, process 230 is halted by means of an asynchronous interrupt 250, which passes control to an “End Execute IMADT” block 259 in which process 230 is complete. Interrupt 250 is typically generated when the OS, browser, IMADT 116, etc. of which process 230 is a part is itself halted. During nominal operation, process 230 continuously loops through the blocks 234, 236, 238, 240, 242, 244, 246 and 248, processing input sequences as a user generates them.

While the claimed subject matter has been shown and described with reference to particular embodiments thereof, it will be understood by those skilled in the art that the foregoing and other changes in form and detail may be made therein without departing from the spirit and scope of the claimed subject matter, including hut not limited to additional, less or modified elements and/or additional, less or modified blocks performed in the same or a different order.

We claim:

1. A method for manipulating images in a web page, comprising:
receiving a transmitted web page on a client device;
scanning the web page to detect a plurality of embedded images;
displaying in conjunction with each image of the plurality of embedded images an image adjustment button;
receiving user input corresponding to a particular image adjustment button;
correlating the particular image adjustment button with a particular image of the plurality of detected embedded images;
modifying the particular image in accordance with the user input to produce a modified image; and
displaying the modified image on the client device.

2. The method of claim 1, the modifying comprising rotating the particular image in response to the user input so that the image is displayed in a orientation that is appropriate for image elements in the particular image.

3. The method of claim 1, the modifying comprising resizing the particular image in response to the user input so that the image fits entirely within boundaries of a displayed portion of the web page.

4. The method of claim 1, wherein the method is executed automatically in conjunction with a web page.

5. The method of claim 1, further comprising toggling between the displaying and not displaying of the image adjustment button corresponding to each image of the plurality of images in response to user input.

6. The method of claim 4, wherein the user input is a click on a toggle image adjustment button displayed in conjunction with the web page.

7. The method of claim 1, wherein the claimed method is executed in conjunction with a plug-in module of a web browser.

8. A system for displaying images in a web page, comprising:
a processor;
a memory, coupled to the processor;
logic, stored on the memory and executed on the processor, to:
receive a transmitted web page on a client device;
scan the web page to detect a plurality of embedded images;
display in conjunction with each image of the plurality of embedded images an image adjustment button;
receive user input corresponding to a particular image adjustment button;
correlate the particular image adjustment button with a particular image of the plurality of detected embedded images;
modify the particular image in accordance with the user input to produce a modified image; and
displaying the modified image on the client device.

9. The system of claim 8, the logic to modify comprising logic to rotate the particular image in response to the user input so that the image is displayed in a orientation that is appropriate for image elements in the particular image.

10. The system of claim 8, the logic to modify comprising logic to resize the particular image in response to the user input so that the image fits entirely within boundaries of a displayed portion of the web page.

11. The system of claim 8, wherein the system executes automatically in conjunction with display of a web page.

12. The system of claim 8, further comprising logic, stored on the memory and executed on the processor, to toggle between the displaying and not displaying of the image adjustment button corresponding to each image of the plurality of images in response to user input.

13. The system of claim 12, wherein the user input is a click on a toggle image adjustment button displayed in conjunction with the web page.

14. The method of claim 1, wherein the claimed method is executed in conjunction with a plug-in module of a web browser.

15. A computer programming product for displaying images in a web page, comprising:
a computer-readable, physical memory;
logic, stored on the memory for execution on a processor, for:
receiving a web page at a client device;
scanning the web page to detect a plurality of embedded images;
displaying in conjunction with each image of the plurality of embedded images an image adjustment button;
receiving user input corresponding to a particular image adjustment button;
correlating the particular image adjustment button with a particular image of the plurality of detected embedded images; and
modifying the particular image in accordance with the user input to produce a modified image; and
displaying the modified image on the client device.

16. The computer programming product of claim 15, the logic for modifying comprising logic for rotating the particular image in response to the user input so that the image is displayed in a orientation that is appropriate for image elements in the particular image.

17. The computer programming product of claim 15, the logic for modifying comprising logic for resizing the particular image in response to the user input so that the image fits entirely within boundaries of a displayed portion of the web page.

18. The computer programming product of claim 15, wherein the logic executes automatically in conjunction with display of a web page.

19. The computer programming product of claim 15, further comprising logic, stored on the memory and executed on the processor, for toggling between the displaying and not displaying of the image adjustment button corresponding to each image of the plurality of images in response to user input.

20. The computer programming product of claim 19, wherein the user input is a click on a toggle image adjustment button displayed in conjunction with the web page.
